(19) United States
(12) Patent Application Publication
(10) Pub. No.: US 2009/0262202 A1
(43) Pub. Date: Oct. 22, 2009

(54) MODULAR TIME LAPSE CAMERA SYSTEM

(76) Inventor: Barney Leonard, Wynnewood, PA (US)

Correspondence Address: IGOE INTELLECTUAL PROPERTY, LLC, 1628 JFK Blvd Suite 1975, PHILADELPHIA, PA, 19103, US

(21) Appl. No.: 12/423,867

(22) Filed: Apr. 15, 2009

Related U.S. Application Data
(60) Provisional application No. 61/045,657, filed on Apr. 17, 2008.

(51) Int. Cl. H04N 5/225; H04N 5/228; H04M 1/00; H04N 5/76

(52) U.S. Cl. 348/207.1; 348/222.1; 455/556.1; 348/231.7; 348/E05.031; 348/E05.024

(57) ABSTRACT

A modular system for the capture of images and associated methods are provided. The system comprises a plurality of lens modules, each comprising a lens, an image sensor, and a communication interface, and a controller unit comprising a housing, a battery, a memory, at least one communication interface, and a processor operative to acquire images from one or more of the plurality of lens modules responsive to at least one of: a determination that a time interval has passed, a sensor input, or a user input, store the images in the memory, and provide the stored images via one of the at least one communication interface.

This application claims the benefit of U.S. Provisional Application No. 61/045,657, filed Apr. 17, 2008.

### TECHNICAL FIELD OF THE INVENTION

The technical field relates generally to photography, and more specifically to a modular time lapse camera system, and even more specifically to a portable time lapse camera system.

### BACKGROUND

Time lapse image capture has formerly been limited to expensive, professional camera systems due to the complexity involved in the capture of a sequence of images. Professional cameras, however, can be bulky and too complicated for spontaneous use in the amateur or consumer markets. While consumer video cameras provide portability, they create motion video with limited resolution relative to still cameras and lack the ability to capture multiple visual perspectives simultaneously. Some still image cameras provide burst or time lapse modes, but also lack the ability to capture multiple perspectives. Digital SLR cameras provide interchangeable lens capabilities, but allow the use of only one lens at a time. Commercial security systems may capture time lapse imagery with multiple perspectives, but these systems tend to be large, require fixed installation, provide poor image quality, and require continuous external power.

A need exists for a portable camera system which allows periodic capture of high-resolution imagery from multiple perspectives. A further need exists for such a portable camera system with a modular design, such that different numbers and types of lens modules may be used to facilitate the simultaneous capture of different perspectives of an event. A still further need exists for such a system to provide configurable and changeable capture intervals for the various perspectives, remote configuration of parameters, and transmission of captured imagery over a network for viewing, editing, or storage.

### SUMMARY OF THE INVENTION

The present invention comprises a modular system for the capture of images. In one embodiment, the system comprises a plurality of lens modules each comprising a lens, an image sensor, and a communication interface, and a controller unit comprising: a housing, a battery, a memory, at least one communication interface, and a processor operative to: acquire images from one or more of the plurality of lens modules responsive to at least one of: a determination that a time interval has passed, a sensor input, or a user input, store the images in the memory, and provide the stored images via one of the at least one communication interface.

In some embodiments, the time interval for acquisition from a first lens module of the plurality of lens modules is different than the time interval for acquisition of images from a second lens module of the plurality of lens modules. In other embodiments, images are acquired at a first time interval during a first time period and at a second time interval during a second time period.

The housing may further comprise a switch for selecting one of a plurality of image acquisition modes. There may be a plurality of image acquisition modes such as time lapse, program, and burst. The processor may be further operative to receive a command to change the mode of image acquisition via at least one of the communication interfaces. A communication interface of the controller unit may be a cellular radio interface.

The communication interface of at least one of the plurality of lens modules may comprise a wireless transceiver, which may use an 802.11, Bluetooth, or ZigBee protocol. In some embodiments the interface of the lens module may also comprise a wired interface, possibly complying with USB or IEEE 1394 standards. A system according to the invention may also comprise a mount attached to the housing. In some embodiments a sensor may be available providing indication of motion. A system according to the invention may also comprise a microphone or a display. In some embodiments, the memory may comprise a flash memory card. A system according to the invention may also comprise a trigger button on the housing.

A system according to the invention may also comprise a GPS receiver. The processor may store images with location information derived from data from the GPS receiver.

In some embodiments, the housing may also comprise a connector allowing direct connection of a lens element. In some embodiments, at least one of the lenses is one of a fisheye lens or a wide angle lens. In some embodiments, the focal length of a first lens module is different from the focal length of a second lens module. In some embodiments, the field of view of a first lens module is substantially different from the field of view of a second lens module.

The present invention also provides a method for gathering time lapse imagery. In some embodiments, the method comprises the steps of, in a controller unit: acquiring images from one or more of a plurality of lens modules, each comprising a lens, a sensor, and a communication interface, responsive to at least one of: a determination that a time interval has passed, a sensor input, or a user input; storing the images in a memory; and providing the stored images via a communication interface of the controller unit. In some embodiments, the time interval for acquisition of images from a first lens module of the plurality of lens modules is different than the time interval for acquisition of images from a second lens module of the plurality of lens modules. In some embodiments, the focal length of a first lens module is different from the focal length of a second lens module. In still other embodiments, the field of view of a first lens module is substantially different from the field of view of a second lens module.

The present invention also provides a method for time lapse capture of images with steps comprising: acquiring first image data from a first lens module; storing the first image data from the first lens module in a memory; receiving second image data from a second lens module; storing the second image data from the second lens module in a memory; acquiring third image data from the first lens module responsive to a determination that a first time interval has passed; storing the third image data from the first lens module in a memory; acquiring fourth image data from a second lens module responsive to a determination that a second time interval has passed; and storing the fourth image data from the second lens module in a memory; wherein the first lens module and the second lens module each comprise a lens, an image sensor, and a communication interface; and wherein the first time interval differs from the second time interval.

### BRIEF DESCRIPTION OF THE DRAWINGS

The foregoing summary, as well as the following detailed description, is better understood when read in conjunction with the attached drawings. For the purpose of illustrating a modular time lapse camera system, there is shown in the drawings exemplary constructions thereof, however, the modular time lapse camera system is not limited to the specific methods and instrumentalities disclosed.

FIG. 1 is an illustration of an embodiment of a modular time lapse camera system mounted on a bicycle.

FIG. 2 is a diagram of an embodiment of a modular time lapse camera system.

FIG. 3 is a diagram of a computing environment in which an embodiment of a modular time lapse camera system is capable of being operated remotely and transmitting images remotely.

FIG. 4 depicts an illustration of a side view of an embodiment of a modular time lapse camera system controller.

### DETAILED DESCRIPTION OF THE PREFERRED EMBODIMENTS

The modular time lapse camera system provides the ability to capture thousands of digital images in a desired sequence and to display the images in much faster than real time. The modular time lapse camera system is lightweight, portable, rugged, easy to use, and reliable. The modular time lapse camera system is the only portable digital camera system on the market wherein the camera body and lens can be separated to accommodate unique mounting and application configurations.

The modular time lapse camera system can be used to capture real life as a sequence of still images captured over time. The modular time lapse camera system can be used to create one's own story (a “story stream”), either as a series of high quality still images or a sequence of images in video form. Software incorporated with the modular time lapse camera system empowers the user to manage the images, edit the images into a picture sequence or story streams to share with family, friends, or anyone on the Internet. The modular time lapse camera system provides the ability to connect to a web site via which users of the modular time lapse camera system can post media and story streams to share with friends and colleagues online. The versatility and small form factor of the modular time lapse camera system allows it to be configurable for various mountings.

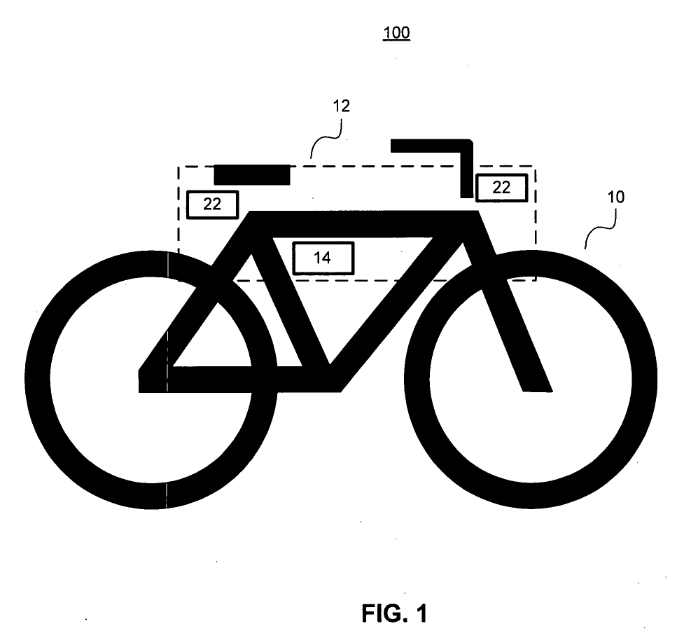

FIG. 1 illustrates an embodiment of the modular time lapse camera system 12, with lens modules 22 and controller 14, mounted to a bicycle 10. Embodiments of the modular time lapse camera systems could also be mounted, for example, to a motorcycle, a car, a boat, or a wearable garment. Various mounting mechanisms are appropriate, such as Velcro®, suction cups, adhesive, screws, nails, magnets, or other fasteners. Various mounting mechanisms would allow the modular time lapse camera system to be used in various applications, such as biking, hiking, skiing, snowboarding, surfing, motocross, motorcycling, cycling, fishing, hang gliding, skydiving, kayaking, rafting, rock climbing, walking a pet, training, law enforcement, diving, snorkeling, construction, or scientific studies.

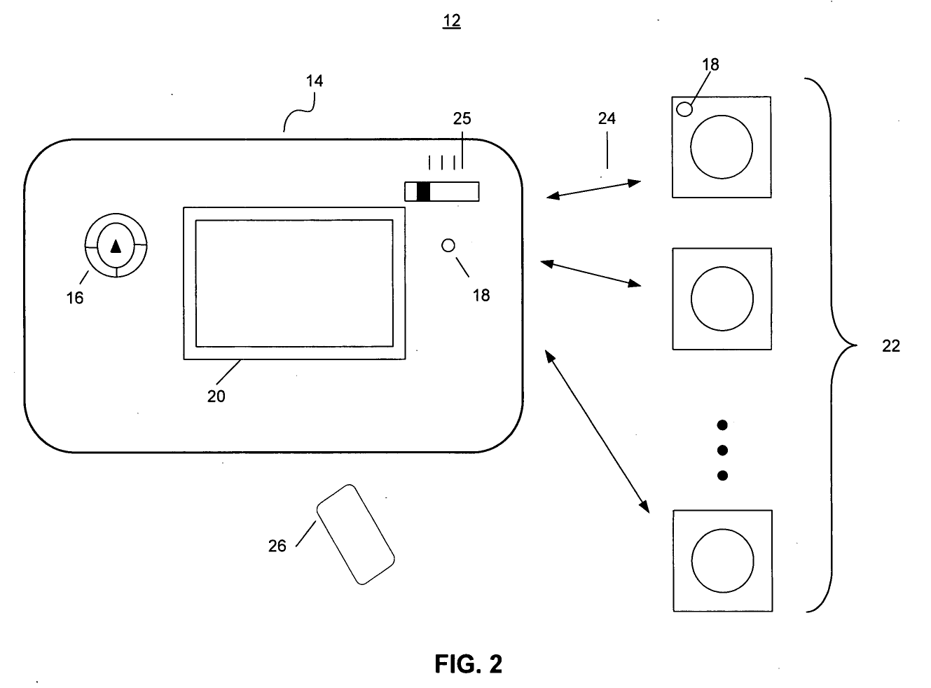

FIG. 2 is an illustration of another embodiment of a modular time lapse camera system 12. The modular time lapse camera system 12 comprises a controller 14 and at least one lens module 22. The controller 14 comprises a control mechanism 16, a display portion 20, and at least one sensor 18. In an exemplary embodiment, the controller 14 comprises a sensor 18, which in some embodiments, serves as a microphone for receiving audio information. The controller 14 can comprise any appropriate mechanical or electronic controller. In an exemplary configuration, the controller 14 comprises a small, business card size device having a thickness of approximately one-half inch. The controller can comprise the capability to communicate via interfaces 24 with other external devices, such as the lens modules 22, via a wired interface, such as a Universal Serial Bus (USB) interface, or a wireless interface. The controller 14 can be used as a controller, triggering mechanism, and/or a data collection mechanism. The control mechanism 16 is utilizable to control functions of the controller 14 and/or the lens module(s) 22. The control mechanism 16 can comprise any appropriate interface, such as a joystick, button, switch, 4-way switch or the like. In an exemplary configuration, the controller 14 comprises a complete digital camera.

The display portion 20 is utilizable to visually render, among other things, a depiction of images obtained via the lens modules 22. In a preferred embodiment, images obtained via the lens modules 22 are subjected to high resolution image processing by a processor capable of presenting images, via the display portion 20, having a resolution of several megapixels. Images can be rendered in color and/or black and white. The high resolution image processing capability can be located in the controller 14, in the lens modules 22, or a combination thereof. In some embodiments, a capture mode switch 25 is provided, allowing selection of modes such as manual, burst, or time lapse.

The modular time lapse camera system may also comprise a viewing screen activation/deactivation mechanism; other user controls for navigating menus, adjusting settings, or manipulating images; a remote triggering/controller sensor; mounting brackets; an LED activity indicator; a low power indicator; or a combination thereof. The modular time lapse camera system can comprise a textured surface to allow for easy manipulation, connectors and ports on its sides to other surfaces.

The lens modules 22 can comprise any variety of combinations of lens modules. For example, the lens modules 22 can each comprise a complete camera (e.g. digital camera). The lens modules 22 can comprise a wide angle lens, a normal angle lens, an ultra wide angle lens (e.g., for landscapes), a fisheye lens (e.g., for specialized applications), a micro lens (e.g. for specialized applications), or a combination thereof. The lens modules 22 can be coupled to the controller 14 via any appropriate interface 24. The interface 24 can comprise a hardwired interface, a wireless interface (e.g., optical, electromagnetic, magnetic), or a combination thereof. In an exemplary embodiment, a lens module 22 can be coupled to another lens module 22. In an exemplary embodiment, the controller 14 controls or selects which lens modules 22 to use and the lens setting for each lens module 22. The controller 14 can control intervalometer functions to determine how often and how quickly images can be obtained via the lens modules 22. In an exemplary embodiment, images can be obtained via each lens module 22 at a range of rates from 2 frames per second to 1 frame per hour. Frame rates can be variable, such that different frame rates can be utilized during different times of the day. For example, a higher frame rate can be used for a set number of hours, as opposed to a slower frame rate for an adjacent block of time. Programming of these frame rates is accomplished through the built in software or software in the controller 14. In an exemplary embodiment, all images recorded by the time lapse camera system are recorded onto industry standard SD or mini SD cards.

The image capture circuitry can be turned on and off to obtain images via the controller 14, or the lens modules 22 can be triggered directly to obtain images or audio. Accordingly, sensors 18 can be configured as triggering sensors or as a sensor configured to receive information. Sensors 18 can be located on the controller 14, on any one or combination of lens modules 22, separate from the controller 14 and the lens modules 22, or a combination thereof. Example sensors 18 may include motion sensors, infrared sensors, vibration sensors, acoustic sensors (e.g., microphone, ultrasonic sensor, etc.), chemical sensors, or timers.

In an exemplary configuration, the modular time lapse camera system 12 comprises the ability to record sound. In such an embodiment, one or any combination of the controller 14 or the lens modules 22 can comprise a sensor 18 for detecting sound. Further, sensors 18 for detecting sound can be separate from the lens modules 22. Sound can be recorded by the lens modules 22, by a separate recording mechanism, by the controller 14, or a combination thereof. During rendering, sound can be played back alone or sound can be correlated with displayed images.

In an exemplary configuration, the modular time lapse camera system 12 can be controlled via a remote controller device 26. In an exemplary embodiment, the remote controller 26 comprises a portable controller capable of controlling all or any subset of the functionality of the controller 14. In an example configuration, controller 14 comprises a digital camera and remote controller 26 is capable of controlling all camera operations. The remote controller 26 is configured to communicate with the controller 14 via any appropriate interface. The interface may comprise for example, a radio frequency interface, such as Bluetooth, or an infrared interface.

The modular time lapse camera system 12 can be configured to obtain images during predetermined times or be triggered by specific events to obtain images. For example, a modular time lapse camera system 12 mounted in a retail store could be triggered to obtain images or audio when motion is detected. A modular time lapse camera system 12 mounted in a chemical plant could be configured to obtain images or audio when specified chemicals are detected. A modular time lapse camera system 12 mounted at a gas station could be configured to obtain images or audio when a car rides over a sensor. A modular time lapse camera system 12 mounted at a traffic intersection could be configured to obtain images or audio during known times of heavy traffic, and obtain images or audio when motion is detected at the intersection. A modular time lapse camera system 12 mounted in a convenience store could be configured to obtain images or audio when an alarm is set by a cashier or be triggered by the remote controller device 26 on the cashier's person. The modular time lapse camera system may be triggered to obtain images or audio when a sound of a predetermined volume level or frequency is detected. The modular time lapse camera system 12 can be configured to obtain images or audio for a predetermined amount of time after being triggered (e.g. 30 second burst, 60 second burst, etc.).

Images obtained via the lens modules 22 can be displayed via the display portion 20 in various manners. Images can be rendered one at a time. Images can be displayed faster than real time. Images can be rendered forward and in reverse. Images can be time stamped such that images associated with a desired time, or time period, can be observed. Additionally, sound can be rendered concurrently in synchronization with the images, interspersed among the images, rendered separately from displaying the images, or a combination thereof. For example, while recording images, sound such as narration and/or ambient sound also can be recorded. Upon playback of the recorded images and sound, the images and sound can be mixed in any desired fashion. For example, the images can be provided as a variable-speed accelerated story stream, and when an image that has corresponding sound is displayed, the speed of the story stream can be slowed to accommodate playback of the audio. This allows the sound (e.g. narration) to be heard while observing the image or images captured while the narration was recorded.

In various embodiments, the controller 14 can include an indicator of remaining power in the controller 14 or lens modules 22. The controller 14 may include a shot counter indicating the number of images obtained. The controller 14 may include an indication of the mode of each of the lens modules 22 (e.g., auto-trigger mode, lens angle, resolution setting, ISO sensitivity, intervalometer settings, etc.). The camera system may include software to allow editing of images, or editing can be accomplished on a processor separate from the camera system. For example, unwanted images can be discarded, extracted, organized, assembled into “story streams,” or transmitted to remote locations (e.g., via the Internet or the like).

In an exemplary embodiment, the modular time lapse camera system comprises a location indicator, such as a Global Positioning System (GPS) receiver. Thus, images or audio captured via the camera system may be rendered with an indication of the location at which the images or audio were obtained. For example, if the modular time lapse camera system is being used during a biking trip, images obtained during the trip can be stamped with an indication of location, time stamped, or a combination thereof. Thus, one can track the itinerary of the trip.

The modular time lapse camera system 12 may be powered by batteries, AC electricity, solar cells, of a combination thereof. For example, lens modules 22 could be located outside and powered by solar cells and a battery backup and, the controller 14 could be located inside a building and power by AC electricity with or without a battery backup.

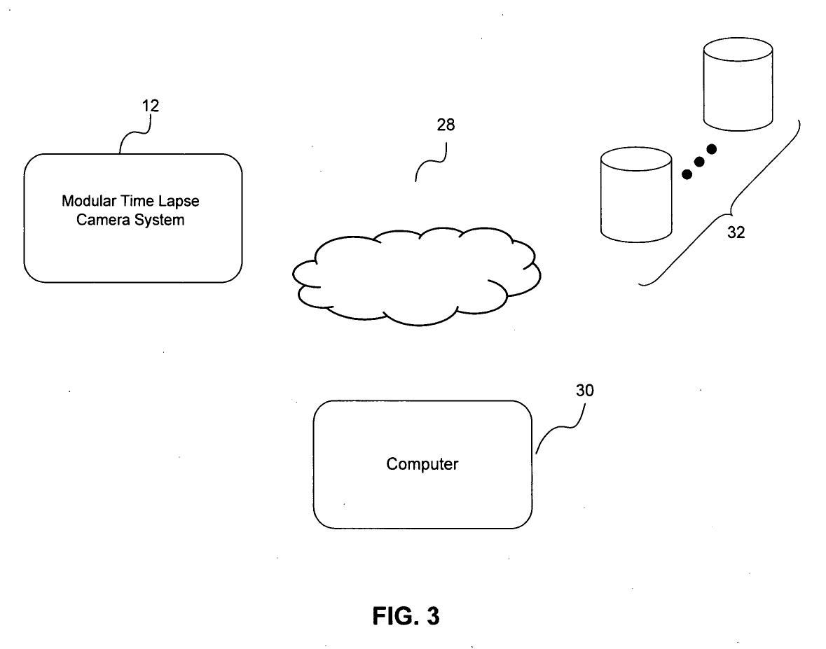

FIG. 3 is a diagram of a computing environment in which the modular time lapse camera system is capable of being operated remotely. As shown in FIG. 3, the modular time lapse camera system 12 can be operated remotely from a computer 30 via a network 28. The computer 30 may be a server, desktop or laptop PC, cell phone, PDA, portable media player, portable email device, portable gaming device, navigation device, non-conventional computing device, such as a kitchen appliance, motor vehicle control, or a combination thereof. In an exemplary embodiment, a password or other appropriate authenticator is utilized to access the modular time lapse camera system 12. The network can comprise any appropriate network, such as a LAN, WAN, the Internet, or the like.

Images can be obtained via the network 28, from the modular time lapse camera system 12 and copied to the computer 30. Images obtained by the modular time lapse camera system 12 may be stored in a database 32. Images may be stored online, possibly in near real time, or offline. Images stored in the database 32 can be retrieved via the network 28 and rendered on the processor 30. For security purposes, images can be encrypted or otherwise protected prior to transmission. Access to stored images may be provided via web, database, or other mechanisms.

In a prototype modular time lapse camera system, the lens modules comprised modified consumer level point-and-shoot digital cameras, wherein each camera had at least 4 GB of storage capacity through the use of industry standard memory cards. This configuration allowed 6,000 images per camera to be stored and later downloaded to hard drive storage. Each modular time lapse camera was housed in a shockproof, waterproof housing.

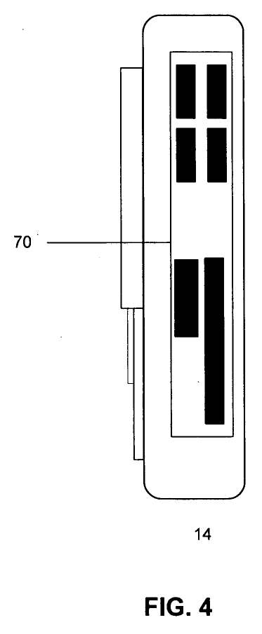

FIG. 4 depicts a side view of an example modular time lapse camera system controller 14. As depicted, sides of the modular time lapse camera system controller 14 can comprise connectors and/or ports 70 for various interfaces. For example connectors/ports 70 can be provided for remote triggering/controller mechanisms, USB compatible interfaces, additional cameras, memory cards, remote lens, or a combination thereof.

While a modular time lapse camera system has been described in connection with the various embodiments of the various figures, it is to be understood that other similar embodiments can be used or modifications and additions can be made to the described embodiment for performing the same function of a modular time lapse camera system within the scope of the claimed invention. For example, one skilled in the art will recognize that a modular time lapse camera system as described may apply to any environment, whether wired or wireless, and may be applied to any number of devices connected via a communications network and interacting across the network. Therefore, a modular time lapse camera system should not be limited to any single embodiment, but rather should be construed in breadth and scope in accordance with herein description.

I claim:

1. A modular system for the capture of images comprising:
a plurality of lens modules each comprising a lens, an image sensor, and a communication interface; and
a controller unit comprising:
a housing;
a battery;
a memory;
at least one communication interface; and
a processor operative to:
acquire images from one or more of said plurality of lens modules responsive to at least one of: a determination that a time interval has passed, a sensor input, or a user input;
store said images in said memory; and
provide said stored images via one of said at least one communication interface.

2. The system of claim 1 wherein the time interval for acquisition from a first lens module of said plurality of lens modules is different than the time interval for acquisition of images from a second lens module of said plurality of lens modules.

3. The system of claim 1 wherein images are acquired at a first time interval during a first time period and at a second time interval during a second time period.

4. The system of claim 1 wherein said housing comprises a switch for selecting one of a plurality of image acquisition modes.

5. The system of claim 4 wherein said plurality of image acquisition modes comprises at least two of: time lapse, program, and burst.

6. The system of claim 1 wherein said processor is further operative to receive a command to change the mode of image acquisition via at least one of said at least one communication interface.

7. The system of claim 1 wherein at least one of said at least one communication interface of said controller unit is a cellular radio interface.

8. The system of claim 1 wherein said communication interface of at least one of said plurality of lens modules comprises a wireless transceiver.

9. The system of claim 8 wherein said wireless transceiver utilizes at least one of an 802.11, Bluetooth, or ZigBee protocol.

10. The system of claim 1 wherein said interface of said lens module comprises a wired interface.

11. The system of claim 10 wherein said wired interface complies with at least one of USB or IEEE 1394 standards.

12. The system of claim 1 further comprising a mount attached to said housing.

13. The system of claim 1 wherein said sensor input is indicative of motion.

14. The system of claim 1 further comprising a microphone.

15. The system of claim 1 further comprising a display.

16. The system of claim 1 wherein said memory comprises a flash memory card.

17. The system of claim 1 further comprising a trigger button on said housing.

18. The system of claim 1 further comprising a GPS receiver.

19. The system of claim 18 wherein said processor stores said images with location information derived from data from said GPS receiver.

20. The system of claim 1 wherein said housing further comprises a connector allowing direct connection of a lens element.

21. The system of claim 1 wherein at least one of said lenses is one of a fisheye lens or a wide angle lens.

22. The system of claim 1 wherein the focal length of a first lens module of said plurality of lens modules is different from the focal length of a second lens module of said plurality of lens modules.

23. The system of claim 1 wherein the field of view of a first lens module of said plurality of lens modules is substantially different from the field of view of a second lens module of said plurality of lens modules.

24. A method for gathering time lapse imagery comprising the steps of, in a controller unit:
acquiring images from one or more of a plurality of lens modules, each comprising a lens, a sensor, and a communication interface, responsive to at least one of: a determination that a time interval has passed, a sensor input, or a user input;
storing said images in a memory; and
providing said stored images via a communication interface of said controller unit.

25. The method of claim 24 wherein the time interval for acquisition of images from a first lens module of said plurality of lens modules is different than the time interval for acquisition of images from a second lens module of said plurality of lens modules.

26. The method of claim 24 wherein the focal length of a first lens module of said plurality of lens modules is different from the focal length of a second lens module of said plurality of lens modules.

27. The method of claim 24 wherein the field of view of a first lens module of said plurality of lens modules is substantially different from the field of view of a second lens module of said plurality of lens modules.

28. A method for time lapse capture of images comprising:
acquiring first image data from a first lens module;
storing said first image data from said first lens module in a memory;
receiving second image data from a second lens module;
storing said second image data from said second lens module in a memory;
acquiring third image data from said first lens module responsive to a determination that a first time interval has passed;
storing said third image data from said first lens module in a memory;
acquiring fourth image data from a second lens module responsive to a determination that a second time interval has passed; and
storing said fourth image data from said second lens module in a memory;
wherein said first lens module and said second lens module each comprise a lens, an image sensor, and a communication interface; and wherein said first time interval differs from said second time interval.
